(19) United States
(12) Patent Application Publication
(10) Pub. No.: US 2025/0119216 A1
(43) Pub. Date: Apr. 10, 2025

(54) OPTICAL REPEATER AND OPTICAL COMMUNICATION SYSTEM

(71) Applicant: NEC Corporation, Tokyo (JP)

(72) Inventor: Kazusa UGAJIN, Tokyo (JP)

(73) Assignee: NEC Corporation, Tokyo (JP)

(21) Appl. No.: 18/901,653

(22) Filed: Sep. 30, 2024

(30) Foreign Application Priority Data
Oct. 4, 2023 (JP) 2023-172884

(51) Int. Cl. H04B 10/29; H04J 14/02

(52) U.S. Cl. CPC H04B 10/29; H04J 14/02

(57) ABSTRACT

To provide an optical repeater and an optical communication system that suppress voltage consumption when an odd number of light sources are provided. An optical repeater according to the present disclosure includes at least n units being an odd number equal to or more than 3, wherein the n units each include an excitation light source, a first optical demultiplexer, a second optical demultiplexer, a first optical multiplexer, and a second optical multiplexer, the first optical demultiplexer demultiplexes excitation light from the excitation light source into 1:n−1, the second optical demultiplexer demultiplexes, into n−1 pieces of excitation light, excitation light demultiplexed by the first optical demultiplexer with a ratio of n−1, the second optical demultiplexer further outputs excitation light demultiplexed to each of the first optical multiplexers belonging to n−1 units other than a unit to which the second optical demultiplexer belongs.

### INCORPORATION BY REFERENCE

This application is based upon and claims the benefit of priority from Japanese patent application No. 2023-172884, filed on Oct. 4, 2023, the disclosure of which is incorporated herein in its entirety by reference.

### TECHNICAL FIELD

The present disclosure relates to an optical repeater and an optical communication system.

### BACKGROUND ART

In an optical communication system intended for long-distance transmission such as a submarine optical cable system, a plurality of optical repeaters are inserted in a transmission path in order to perform electric compensation for attenuation of an optical signal.

International Patent Publication WO2018/097074 discloses performing multiplexing and demultiplexing of excitation light by using a nonequal branching coupler in an optical repeater including a plurality of excitation light sources.

In an optical communication system, an influence of a voltage drop of an optical repeater becomes large along with the number optical repeaters to be inserted. Therefore, suppression of a voltage drop in an inside of the optical repeater is required.

In order to secure a voltage drop and reliability of the optical repeater, International Patent Publication WO2018/097074 discloses that a plurality of pieces of excitation light are multiplexed and demultiplexed by the optical repeater including a plurality of excitation light sources, and exited by a plurality of optical amplifiers.

### SUMMARY

However, when an optical repeater includes an odd number of excitation light sources, a part of an optical amplifier needs to be terminated, electric power of excitation light to be used for an optical amplifier to be terminated is wasted, and therefore, the method described above may not be said to be preferable.

In view of the above, an example object of the present disclosure is to provide an optical repeater and an optical communication system that suppress voltage consumption when an odd number of light sources are provided.

In a first example aspect, an optical repeater includes at least n units being an odd number equal to or more than 3, wherein the n units each include an excitation light source, a first optical demultiplexer, a second optical demultiplexer, a first optical multiplexer, and a second optical multiplexer, the first optical demultiplexer demultiplexes excitation light from the excitation light source into 1:n−1, the second optical demultiplexer demultiplexes, into n−1 pieces of excitation light, excitation light demultiplexed by the first optical demultiplexer with a ratio of n−1, the second optical demultiplexer further outputs excitation light demultiplexed to each of the first optical multiplexers belonging to n−1 units other than a unit to which the second optical demultiplexer belongs, the first optical multiplexer multiplexes, into a single piece of excitation light, excitation light being input by each of the optical demultiplexers belonging to n−1 units other than a unit to which the first optical multiplexer belongs, and outputs the single piece of excitation light to the second optical multiplexer, and the second optical multiplexer multiplexes excitation light demultiplexed by the first optical demultiplexer with a ratio of 1 and the single piece of excitation light multiplexed by the first optical multiplexer.

In a second example aspect, an optical repeater includes at least n units being an odd number equal to or more than 3, wherein the n units each include an excitation light source, an optical demultiplexer, and an optical multiplexer, the optical demultiplexer demultiplexes excitation light from the excitation light source into n pieces of excitation light, the optical demultiplexer further outputs the n pieces of excitation light to the optical multiplexers of the n units, respectively, and the optical multiplexer multiplexes, into a single piece of excitation light, pieces of excitation light being input by the optical demultiplexers of the n units.

In a third example aspect, an optical repeater includes: a first unit including a first excitation light source, a first optical demultiplexer, a second optical demultiplexer, a first optical multiplexer, and a second optical multiplexer; a second unit including a second excitation light source, a third optical demultiplexer, a fourth optical demultiplexer, a third optical multiplexer, and a fourth optical multiplexer; and a third unit including a third excitation light source, a fifth optical demultiplexer, a sixth optical demultiplexer, a fifth optical multiplexer, and a sixth optical multiplexer, wherein the first optical demultiplexer demultiplexes, in 1:2, excitation light being output by the first excitation light source, into first excitation light with a ratio of 1 and second excitation light with a ratio of 2, the third optical demultiplexer demultiplexes, in 1:2, excitation light being output by the second excitation light source, into third excitation light with a ratio of 1 and fourth excitation light with a ratio of 2, the fifth optical demultiplexer demultiplexes, in 1:2, excitation light being output by the third excitation light source, into fifth excitation light with a ratio of 1 and sixth excitation light with a ratio of 2, the second optical demultiplexer demultiplexes the second excitation light in 1:1 into second primary excitation light and second secondary excitation light, the fourth optical demultiplexer demultiplexes the fourth excitation light in 1:1 into fourth primary excitation light and fourth secondary excitation light, the sixth optical demultiplexer demultiplexes the sixth excitation light in 1:1 into sixth primary excitation light and sixth secondary excitation light, the first optical multiplexer multiplexes the fourth primary excitation light and the sixth primary excitation light into seventh excitation light, the third optical multiplexer multiplexes the second primary excitation light and the sixth secondary excitation light into eighth excitation light, the fifth optical multiplexer multiplexes the second secondary excitation light and the fourth secondary excitation light into ninth excitation light, the second optical multiplexer multiplexes the first excitation light and the seventh excitation light, the fourth optical multiplexer multiplexes the second excitation light and the eighth excitation light, and the sixth optical multiplexer multiplexes the third excitation light and the ninth excitation light.

In a fourth example aspect, an optical repeater includes: a first unit including a first excitation light source, a first optical demultiplexer, and a first optical multiplexer; a second unit including a second excitation light source, a second optical demultiplexer, and a second optical multiplexer; and a third unit including a third excitation light source, a third optical demultiplexer, and a third optical multiplexer, wherein the first optical demultiplexer demultiplexes, into three, excitation light being output by the first excitation light source, and forms first excitation light, second excitation light, and third excitation light, the second optical demultiplexer demultiplexes, into three, excitation light being output by the second excitation light source, and forms fourth excitation light, fifth excitation light, and sixth excitation light, the third optical demultiplexer demultiplexes, into three, excitation light being output by the third excitation light source, and forms seventh excitation light, eighth excitation light, and ninth excitation light, the first optical multiplexer multiplexes the first excitation light, the fourth excitation light, and the seventh excitation light, the second optical multiplexer multiplexes the second excitation light, the fifth excitation light, and the eighth excitation light, and the third optical multiplexer multiplexes the third excitation light, the sixth excitation light, and the ninth excitation light.

In a fifth example aspect, an optical communication system includes: an optical transmitter configured to transmit an optical signal; an optical receiver configured to receive the optical signal; an optical fiber configured to transfer the optical signal; and the above-described optical repeater to be inserted in the optical fiber.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a configuration diagram of an optical repeater according to the present disclosure;

FIG. 2 is a diagram illustrating an operation of the optical repeater according to the present disclosure;

FIG. 3 is a configuration diagram of an optical communication system according to the present disclosure;

FIG. 4 is a configuration diagram of an optical repeater according to the present disclosure; and

FIG. 5 is a configuration diagram of an optical repeater according to the present disclosure.

### EXAMPLE EMBODIMENT

### First Example Embodiment

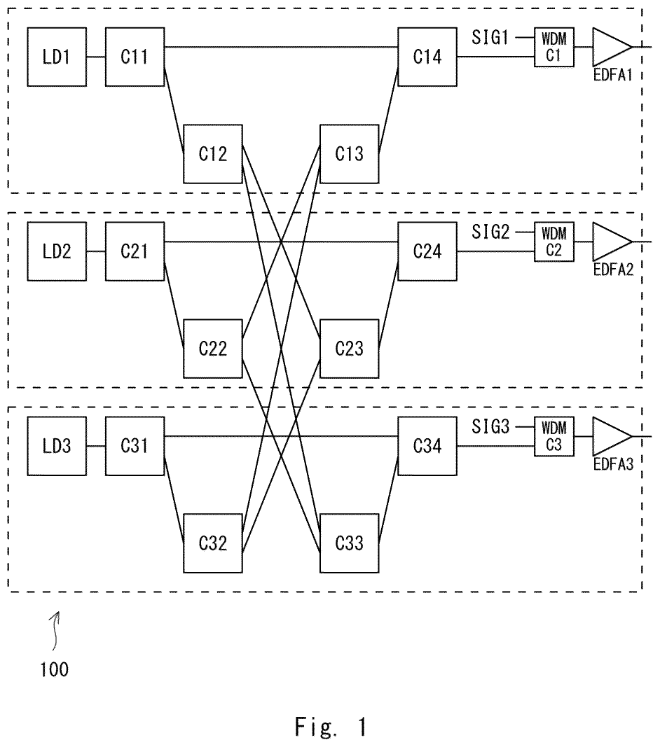

Hereinafter, the present disclosure is described with reference to the drawings. FIG. 1 illustrates a configuration of an optical repeater according to the present disclosure. An optical repeater 100 includes n excitation light sources being an odd number. Note that, in FIG. 1, a case where n=3 is described in order to facilitate understanding of the present disclosure.

The optical repeater 100 includes three excitation light sources, three first optical demultiplexers, three second optical demultiplexers, three first optical multiplexers, and three second optical multiplexers. FIG. 1 describes excitation light sources: LD1, LD2, and LD3, first optical demultiplexers: C11, C21, and C31, second optical demultiplexers: C12, C22, and C32, first optical multiplexers: C13, C23, and C33, and second optical multiplexers: C14, C24, and C34, respectively.

Further, the optical repeater 100 includes three wavelength division multiplexing couplers and three optical amplifiers. FIG. 1 describes wavelength division multiplexing couplers: WDMC1, WDMC2, and WDMC3, and optical amplifiers: EDFA1, EDFA2, and EDFA3, respectively.

Herein, a part of the optical repeater 100 surrounded by a broken line in FIG. 1, i.e., one excitation light source, one first optical demultiplexer, one second optical demultiplexer, one first optical multiplexer, one second optical multiplexer, one wavelength division multiplexing coupler, and one optical amplifier are seen as one unit. In other words, the optical repeater 100 includes three units that are a first unit, a second unit, and a third unit.

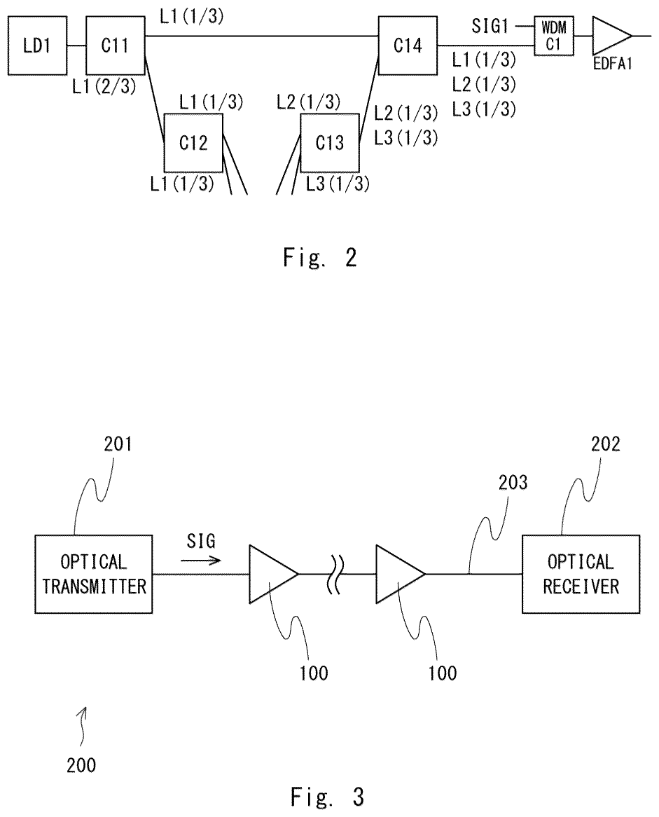

Herein, an amplification operation of an optical signal in the optical repeater 100 is described by using FIG. 2. FIG. 2 takes up the first unit of the optical repeater 100.

The excitation light source LD1 outputs excitation light L1. The first optical demultiplexer C11 demultiplexes, in 1:2, the output excitation light L1, into excitation light L1 (⅓) with a ratio of 1, i.e., light intensity is ⅓ of the excitation light L1, and excitation light L1 (⅔) with a ratio of 2, i.e., light intensity is ⅔ of the excitation light L1.

Note that, although omitted in FIG. 2, operations in the second unit and the third unit are similar to that in the first unit. Therefore, the first optical demultiplexer C21 of the second unit demultiplexes excitation light L2 output from the excitation light source LD2, into excitation light L2 (⅓) with a ratio of 1, and excitation light L2 (⅔) with a ratio of 2. Moreover, the first optical demultiplexer C31 of the third unit demultiplexes excitation light L3 output from the excitation light source LD3 into excitation light L3 (⅓) with a ratio of 1, and excitation light L3 (⅔) with a ratio of 2.

The second optical demultiplexer C12 demultiplexes, in 1:1, the excitation light L1 (⅔), output from the first optical demultiplexer C11, with a ratio of 2, into two pieces of excitation light L1 (⅓). Next, the second optical demultiplexer C12 outputs the two pieces of demultiplexed excitation light L1 (⅓) to the first optical multiplexer C23 of the second unit and the first optical multiplexer C33 of the third unit, respectively. In other words, the second optical demultiplexer C12 of the first unit outputs pieces of excitation light demultiplexed to units (the second unit and the third unit) other than a unit (the first unit) to which the second optical demultiplexer C12 belongs, respectively.

Similarly, the second optical demultiplexer C22 of the second unit demultiplexes, in 1:1, the excitation light L2 (⅔), output from the first optical demultiplexer C22, with a ratio of 2, into two pieces of excitation light L2 (⅓). Next, the second optical demultiplexer C22 of the second unit outputs the two pieces of demultiplexed excitation light L2 (⅓) to the first optical multiplexer C13 of the first unit and the first optical multiplexer C33 of the third unit, respectively.

Moreover, the second optical demultiplexer C32 of the third unit demultiplexes, in 1:1, the excitation light L3 (⅔), output from the first optical demultiplexer C32, with a ratio of 2, into two pieces of excitation light L3 (⅓). Next, the second optical demultiplexer C32 of the third unit outputs the two pieces of demultiplexed excitation light L3 (⅓) to the first optical multiplexer C13 of the first unit and the first optical multiplexer C23 of the second unit, respectively.

The first optical multiplexer C13 of the first unit multiplexes the excitation light L2 (⅓) output from the second optical demultiplexer C22 of the second unit and the excitation light L3 (⅓) output from the second optical demultiplexer C32 of the third unit. In other words, the first optical multiplexer C13 of the first unit multiplexes, into a single piece of excitation light, pieces of excitation light respectively output from units (the second unit and the third unit) other than a unit (the first unit) to which the first optical multiplexer C13 belongs.

Similarly, the first optical multiplexer C23 of the second unit multiplexes, into a single piece of excitation light, the excitation light L1 (⅓) output from the second optical demultiplexer C12 of the first unit and the excitation light L3 (⅓) output from the second optical demultiplexer C32 of the third unit. Moreover, the first optical multiplexer C33 of the third unit multiplexes, into a single piece of excitation light, the excitation light L1 (⅓) output from the second optical demultiplexer C12 of the first unit and the excitation light L2 (⅓) output from the second optical demultiplexer C22 of the second unit.

The second optical multiplexer C14 of the first unit multiplexes the excitation light L1 (⅓) output from the first optical demultiplexer C11, with a ratio of 1, and a single piece of excitation light output from the first optical multiplexer C13. Similarly, the second optical multiplexer C24 of the second unit multiplexes the excitation light L2 (⅓) output from the first optical demultiplexer C21, with a ratio of 1, and a single piece of excitation light output from the first optical multiplexer C23. Moreover, the second optical multiplexer C34 of the third unit multiplexes the excitation light L3 (⅓) output from the first optical demultiplexer C31, with a ratio of 1, and a single piece of excitation light output from the first optical multiplexer C33.

It is preferable to use a 1×2 optical fiber coupler for each of the first optical demultiplexer, the second optical demultiplexer, the first optical multiplexer, and the second optical multiplexer according to the present example embodiment. Moreover, in a case of an odd number being larger than n=3, it is preferable to use a 1×2 optical fiber coupler for each of the first optical demultiplexer and the second optical multiplexer, and use a 1×(n−1) optical fiber coupler for each of the second optical demultiplexer and the first optical multiplexer.

The wavelength division multiplexing coupler WDMC1 of the first unit multiplexes an optical signal SIG1 input to the first unit, and excitation light multiplexed by the second optical multiplexer C14, and outputs multiplexed excitation light to the optical amplifier EDFA1. The optical amplifier EDFA1 of the first unit amplifies the optical signal SIG1 by using the excitation light multiplexed by the wavelength division multiplexing coupler WDMC1.

Similarly, the wavelength division multiplexing coupler WDMC2 of the second unit multiplexes an optical signal SIG2 input to the second unit, and excitation light multiplexed by the second optical multiplexer C24, and outputs multiplexed excitation light to the optical amplifier EDFA2. The optical amplifier EDFA2 of the second unit amplifies the optical signal SIG2 by using the excitation light multiplexed by the wavelength division multiplexing coupler WDMC2.

Moreover, the wavelength division multiplexing coupler WDMC3 of the third unit multiplexes an optical signal SIG3 input to the third unit, and excitation light multiplexed by the second optical multiplexer C34, and outputs multiplexed excitation light to the optical amplifier EDFA3. The optical amplifier EDFA3 of the third unit amplifies the optical signal SIG3 by using the excitation light multiplexed by the wavelength division multiplexing coupler WDMC3.

It is preferable to use an erbium doped fiber amplifier (EDFA) for the optical amplifier according to the present example embodiment.

In this way, since the optical repeater according to the present disclosure does not need to terminate a part of the optical amplifier even when the optical repeater includes an odd number of excitation light sources, electric power of excitation light is not wasted, and it becomes possible to suppress voltage consumption. Further, in the optical repeater according to the present disclosure, since supply of excitation light becomes possible even when some of excitation light sources fail among the excitation light sources LD1, LD2, and LD3, it becomes possible to hold signal optical amplification while securing redundancy.

### Second Example Embodiment

Next, an optical communication system including an optical repeater according to the present disclosure is described. FIG. 3 illustrates a configuration of the optical communication system according to the present disclosure. An optical communication system 200 includes an optical transmitter 201, an optical receiver 202, an optical fiber 203, and an optical repeater 100 described in the first example embodiment. The optical transmitter 201 transmits an optical signal SIG, and the optical receiver 202 receives the optical signal SIG transmitted from the optical transmitter 201. The optical signal SIG is transferred via the optical fiber 203.

In an optical communication system intended for long-distance transfer such as a submarine optical cable system, attenuation of the optical signal SIG becomes more significant as a distance in which the optical signal SIG is transferred is longer. Thus, the optical signal SIG is amplified by inserting a plurality of the optical repeaters 100 between the optical transmitter 201 and the optical receiver 202.

The optical repeater 100 according to the present example embodiment includes a configuration similar to that of the optical repeater 100 described in the first example embodiment. With such a configuration, even when an optical repeater includes an odd number of light sources, an optical communication system that suppresses voltage consumption and secures redundancy can be provided.

### Third Example Embodiment

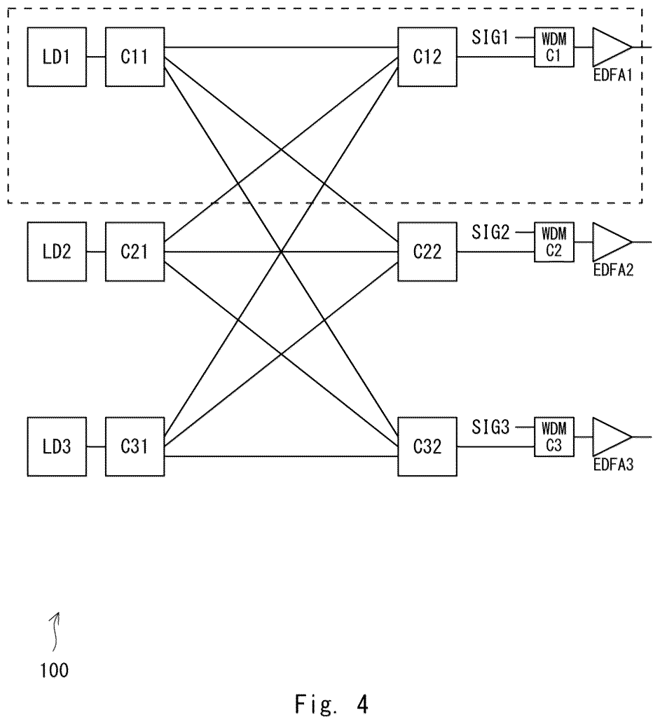

Next, an optical repeater having a configuration different from that of an optical repeater according to the first example embodiment is described. FIG. 4 illustrates a configuration of the optical repeater according to the present disclosure. An optical repeater 100 includes n excitation light sources being an odd number. Note that, in FIG. 4, a case where n=3 is described in order to facilitate understanding of the present disclosure.

The optical repeater 100 includes three excitation light sources, three optical demultiplexers, and three optical multiplexers. FIG. 4 describes excitation light sources: LD1, LD2, and LD3, optical demultiplexers: C11, C21, and C31, and optical multiplexers: C12, C22, and C32, respectively.

Further, the optical repeater 100 includes three wavelength division multiplexing couplers and three optical amplifiers. FIG. 4 describes wavelength division multiplexing couplers: WDMC1, WDMC2, and WDMC3, and optical amplifiers: EDFA1, EDFA2, and EDFA3, respectively.

Similarly to the first example embodiment, a part of the optical repeater 100 surrounded by a broken line in FIG. 4, i.e., one excitation light source, one optical demultiplexer, one optical multiplexer, one wavelength division multiplexing coupler, and one optical amplifier are seen as one unit. In other words, the optical repeater 100 includes three units that are a first unit, a second unit, and a third unit.

The excitation light source LD1 outputs excitation light. The optical demultiplexer C11 demultiplexes the output excitation light into three, and outputs pieces of demultiplexed excitation light to the optical multiplexers C12, C22, and C32 of each unit, respectively. Note that, operations in the second unit and the third unit are similar to that in the first unit. Therefore, the optical demultiplexer C21 of the second unit demultiplexes, into three, excitation light output from the excitation light source LD2, and outputs pieces of demultiplexed excitation light to the optical multiplexers C12, C22, and C32 of each unit, respectively. Moreover, the optical demultiplexer C31 of the third unit demultiplexes, into three, excitation light output from the excitation light source LD3, and outputs pieces of demultiplexed excitation light to the optical multiplexers C12, C22, and C32 of each unit, respectively.

The optical multiplexer C12 of the first unit multiplexes, into a single piece of excitation light, the pieces of excitation light input from the optical demultiplexers C11, C21, and C31 of each unit, and outputs the single piece of excitation light to the wavelength division multiplexing coupler WDMC1. Similarly, the optical multiplexer C22 of the second unit multiplexes, into a single piece of excitation light, the pieces of excitation light input from the optical demultiplexers C11, C21, and C31 of each unit, and outputs the single piece of excitation light to the wavelength division multiplexing coupler WDMC2. Moreover, the optical multiplexer C32 of the third unit multiplexes, into a single piece of excitation light, the pieces of excitation light input from the optical demultiplexers C11, C21, and C31 of each unit, and outputs the single piece of excitation light to the wavelength division multiplexing coupler WDMC3.

It is preferable to use a 1×3 optical fiber coupler for each of the optical demultiplexer and the optical multiplexer according to the present example embodiment. Moreover, in a case of an odd number being larger than n=3, it is preferable to use 1×n optical fiber couplers for each of the optical demultiplexer and the optical multiplexer according to the present example embodiment.

The wavelength division multiplexing coupler WDMC1 of the first unit multiplexes an optical signal SIG1 input to the first unit, and excitation light multiplexed by the optical multiplexer C12, and outputs multiplexed excitation light to the optical amplifier EDFA1. The optical amplifier EDFA1 of the first unit amplifies the optical signal SIG1 by using the excitation light multiplexed by the wavelength division multiplexing coupler WDMC1.

Similarly, the wavelength division multiplexing coupler WDMC2 of the second unit multiplexes an optical signal SIG2 input to the second unit, and excitation light multiplexed by the optical multiplexer C22, and outputs multiplexed excitation light to the optical amplifier EDFA2. The optical amplifier EDFA2 of the second unit amplifies the optical signal SIG2 by using the excitation light multiplexed by the wavelength division multiplexing coupler WDMC2.

Moreover, the wavelength division multiplexing coupler WDMC3 of the third unit multiplexes an optical signal SIG3 input to the third unit, and excitation light multiplexed by the optical multiplexer C32, and outputs multiplexed excitation light to the optical amplifier EDFA3. The optical amplifier EDFA3 of the third unit amplifies the optical signal SIG3 by using the excitation light multiplexed by the wavelength division multiplexing coupler WDMC3.

It is preferable to use an erbium doped fiber amplifier (EDFA) for the optical amplifier according to the present example embodiment.

In this way, since the optical repeater according to the present disclosure does not need to terminate a part of the optical amplifier even when the optical repeater includes an odd number of excitation light sources, electric power of excitation light is not wasted, and it becomes possible to suppress voltage consumption. Further, in the optical repeater according to the present disclosure, since supply of excitation light becomes possible even when some of excitation light sources fail among the excitation light sources LD1, LD2, and LD3, it becomes possible to hold signal optical amplification while securing redundancy.

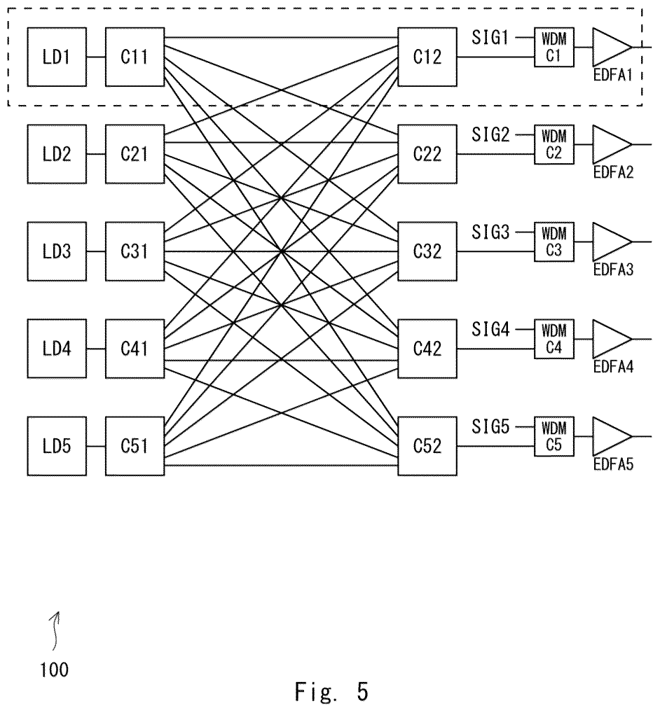

FIG. 5 illustrates a configuration of an optical repeater according to the present disclosure when n=5. The optical repeater 100 includes five excitation light sources, five optical demultiplexers, and five optical multiplexers. FIG. 5 describes excitation light sources: LD1, LD2, LD3, LD4, and LD5, optical demultiplexers: C11, C21, C31, C41, and C51, and optical multiplexers: C12, C22, C32, C42, and C52, respectively.

Further, the optical repeater 100 includes five wavelength division multiplexing couplers and five optical amplifiers. FIG. 5 describes wavelength division multiplexing couplers: WDMC1, WDMC2, WDMC3, WDMC4, and WDMC5, and optical amplifiers: EDFA1, EDFA2, EDFA3, EDFA4, and EDFA5, respectively.

Similarly to the first example embodiment, a part of the optical repeater 100 surrounded by a broken line in FIG. 5, i.e., one excitation light source, one optical demultiplexer, one optical multiplexer, one wavelength division multiplexing coupler, and one optical amplifier are seen as one unit. In other words, the optical repeater 100 includes five units that are a first unit, a second unit, a third unit, a fourth unit, and a fifth unit.

The excitation light source LD1 outputs excitation. The optical demultiplexer C11 demultiplexes the output excitation light into five, and outputs pieces of demultiplexed excitation light to the optical multiplexers C12, C22, C32, C42, and C52 of each unit, respectively. Note that, operations in the second to fifth units are similar to that in the first unit.

The optical multiplexer C12 of the first unit multiplexes, into a single piece of excitation light, the pieces of excitation light input from the optical demultiplexers C11, C21, C31, C41, and C51 of each unit, and outputs the single piece of excitation light to the wavelength division multiplexing coupler WDMC1. Note that, operations in the second to fifth units are similar to that in the first unit.

It is preferable to use a 1×5 optical fiber coupler for each of the optical demultiplexer and the optical multiplexer according to the present example embodiment.

The wavelength division multiplexing coupler WDMC1 of the first unit multiplexes an optical signal SIG1 input to the first unit, and excitation light multiplexed by the optical multiplexer C12, and outputs multiplexed excitation light to the optical amplifier EDFA1. The optical amplifier EDFA1 of the first unit amplifies the optical signal SIG1 by using the excitation light multiplexed by the wavelength division multiplexing coupler WDMC1. Note that, operations in the second to fifth units are similar to that in the first unit.

In this way, since the optical repeater according to the present disclosure does not need to terminate a part of the optical amplifier even when the optical repeater includes an odd number of excitation light sources, electric power of excitation light is not wasted, and it becomes possible to suppress voltage consumption. Further, in the optical repeater according to the present disclosure, since supply of excitation light becomes possible even when some of excitation light sources fail among the excitation light sources LD1 to LD5, it becomes possible to hold signal optical amplification while securing redundancy.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

Some or all of the above-described example embodiments may be described as the following supplementary notes, but are not limited thereto.

### (Supplementary Note 1)

An optical repeater including at least n units being an odd number equal to or more than 3, wherein
the n units each include an excitation light source, a first optical demultiplexer, a second optical demultiplexer, a first optical multiplexer, and a second optical multiplexer,
the first optical demultiplexer demultiplexes excitation light from the excitation light source into 1:n−1,
the second optical demultiplexer demultiplexes, into n−1 pieces of excitation light, excitation light demultiplexed by the first optical demultiplexer with a ratio of n−1,
the second optical demultiplexer further outputs excitation light demultiplexed to each of the first optical multiplexers belonging to n−1 units other than a unit to which the second optical demultiplexer belongs,
the first optical multiplexer multiplexes, into a single piece of excitation light, excitation light being input by each of the optical demultiplexers belonging to n−1 units other than a unit to which the first optical multiplexer belongs, and outputs the single piece of excitation light to the second optical multiplexer, and
the second optical multiplexer multiplexes excitation light demultiplexed by the first optical demultiplexer with a ratio of 1 and the single piece of excitation light multiplexed by the first optical multiplexer.

### (Supplementary Note 2)

The optical repeater according to supplementary note 1, wherein each of the n units further includes
a wavelength division multiplexing coupler configured to multiplex an optical signal, and excitation light multiplexed by the second optical multiplexer, and
an optical amplifier configured to input and amplify light multiplexed by the wavelength division multiplexing coupler.

### (Supplementary Note 3)

The optical repeater according to supplementary note 1 or 2, wherein the first optical demultiplexer, the first optical multiplexer, the second optical demultiplexer, and the second optical multiplexer each include an optical fiber coupler.

### (Supplementary Note 4)

An optical communication system including:
an optical transmitter configured to transmit an optical signal;
an optical receiver configured to receive the optical signal;
an optical fiber configured to transfer the optical signal; and
the optical repeater according to any one of supplementary notes 1 to 3 being inserted in the optical fiber.

### (Supplementary Note 5)

An optical repeater including at least n units being an odd number equal to or more than 3, wherein
the n units each include an excitation light source, an optical demultiplexer, and an optical multiplexer,
the optical demultiplexer demultiplexes excitation light from the excitation light source into n pieces of excitation light,
the optical demultiplexer further outputs the n pieces of excitation light to the optical multiplexers of the n units, respectively, and
the optical multiplexer multiplexes, into a single piece of excitation light, pieces of excitation light being input by the optical demultiplexers of the n units.

### (Supplementary Note 6)

The optical repeater according to supplementary note 5, wherein each of the n units further includes
a wavelength division multiplexing coupler configured to multiplex an optical signal, and excitation light multiplexed by the optical multiplexer, and
an optical amplifier configured to input and amplify light multiplexed by the wavelength division multiplexing coupler.

### (Supplementary Note 7)

The optical repeater according to supplementary note 5 or 6, wherein the optical demultiplexer and the optical multiplexer each include an optical fiber coupler.

### (Supplementary Note 8)

An optical communication system including:
an optical transmitter configured to transmit an optical signal;
an optical receiver configured to receive the optical signal;
an optical fiber configured to transfer the optical signal; and
the optical repeater according to any one of supplementary notes 5 to 7 being inserted in the optical fiber.

### (Supplementary Note 9)

An optical repeater including:
a first unit including a first excitation light source, a first optical demultiplexer, a second optical demultiplexer, a first optical multiplexer, and a second optical multiplexer;
a second unit including a second excitation light source, a third optical demultiplexer, a fourth optical demultiplexer, a third optical multiplexer, and a fourth optical multiplexer; and
a third unit including a third excitation light source, a fifth optical demultiplexer, a sixth optical demultiplexer, a fifth optical multiplexer, and a sixth optical multiplexer, wherein
the first optical demultiplexer demultiplexes, in 1:2, excitation light being output by the first excitation light source, into first excitation light with a ratio of 1 and second excitation light with a ratio of 2,
the third optical demultiplexer demultiplexes, in 1:2, excitation light being output by the second excitation light source, into third excitation light with a ratio of 1 and fourth excitation light with a ratio of 2,
the fifth optical demultiplexer demultiplexes, in 1:2, excitation light being output by the third excitation light source, into fifth excitation light with a ratio of 1 and sixth excitation light with a ratio of 2,
the second optical demultiplexer demultiplexes the second excitation light in 1:1 into second primary excitation light and second secondary excitation light,
the fourth optical demultiplexer demultiplexes the fourth excitation light in 1:1 into fourth primary excitation light and fourth secondary excitation light,
the sixth optical demultiplexer demultiplexes the sixth excitation light in 1:1 into sixth primary excitation light and sixth secondary excitation light,
the first optical multiplexer multiplexes the fourth primary excitation light and the sixth primary excitation light into seventh excitation light,
the third optical multiplexer multiplexes the second primary excitation light and the sixth secondary excitation light into eighth excitation light,
the fifth optical multiplexer multiplexes the second secondary excitation light and the fourth secondary excitation light into ninth excitation light,
the second optical multiplexer multiplexes the first excitation light and the seventh excitation light,
the fourth optical multiplexer multiplexes the second excitation light and the eighth excitation light, and
the sixth optical multiplexer multiplexes the third excitation light and the ninth excitation light.

### (Supplementary Note 10)

The optical repeater according to supplementary note 9, wherein
the first unit further includes a first wavelength division multiplexing coupler configured to multiplex a first optical signal, and excitation light multiplexed by the second optical multiplexer, and a first optical amplifier configured to input and amplify light multiplexed by the first wavelength division multiplexing coupler,
the second unit further includes a second wavelength division multiplexing coupler configured to multiplex a second optical signal, and excitation light multiplexed by the fourth optical multiplexer, and a second optical amplifier configured to input and amplify light multiplexed by the second wavelength division multiplexing coupler, and
the third unit further includes a third wavelength division multiplexing coupler configured to multiplex a third optical signal, and excitation light multiplexed by the sixth optical multiplexer, and a third optical amplifier configured to input and amplify light multiplexed by the third wavelength division multiplexing coupler.

### (Supplementary Note 11)

The optical repeater according to supplementary note 9 or 10, wherein the first optical demultiplexer, the second optical demultiplexer, the first optical multiplexer, the second optical multiplexer, the third optical demultiplexer, the fourth optical demultiplexer, the third optical multiplexer, the fourth optical multiplexer, the fifth optical demultiplexer, the sixth optical demultiplexer, the fifth optical multiplexer, and the sixth optical multiplexer each include an optical fiber coupler.

### (Supplementary Note 12)

An optical communication system including:
an optical transmitter configured to transmit an optical signal;
an optical receiver configured to receive the optical signal;
an optical fiber configured to transfer the optical signal; and
the optical repeater according to any one of supplementary notes 9 to 11 being inserted in the optical fiber.

### (Supplementary Note 13)

An optical repeater including:
a first unit including a first excitation light source, a first optical demultiplexer, and a first optical multiplexer;
a second unit including a second excitation light source, a second optical demultiplexer, and a second optical multiplexer; and
a third unit including a third excitation light source, a third optical demultiplexer, and a third optical multiplexer, wherein
the first optical demultiplexer demultiplexes, into three, excitation light being output by the first excitation light source, and forms first excitation light, second excitation light, and third excitation light,
the second optical demultiplexer demultiplexes, into three, excitation light being output by the second excitation light source, and forms fourth excitation light, fifth excitation light, and sixth excitation light,
the third optical demultiplexer demultiplexes, into three, excitation light being output by the third excitation light source, and forms seventh excitation light, eighth excitation light, and ninth excitation light,
the first optical multiplexer multiplexes the first excitation light, the fourth excitation light, and the seventh excitation light,
the second optical multiplexer multiplexes the second excitation light, the fifth excitation light, and the eighth excitation light, and
the third optical multiplexer multiplexes the third excitation light, the sixth excitation light, and the ninth excitation light.

### (Supplementary Note 14)

The optical repeater according to supplementary note 13, wherein
the first unit further includes a first wavelength division multiplexing coupler configured to multiplex a first optical signal, and excitation light multiplexed by the first optical multiplexer, and a first optical amplifier configured to input and amplify light multiplexed by the first wavelength division multiplexing coupler,
the second unit further includes a second wavelength division multiplexing coupler configured to multiplex a second optical signal, and excitation light multiplexed by the second optical multiplexer, and a second optical amplifier configured to input and amplify light multiplexed by the second wavelength division multiplexing coupler, and
the third unit further includes a third wavelength division multiplexing coupler configured to multiplex a third optical signal, and excitation light multiplexed by the third optical multiplexer, and a third optical amplifier configured to input and amplify light multiplexed by the third wavelength division multiplexing coupler.

### (Supplementary Note 15)

The optical repeater according to supplementary note 13 or 14, wherein the first optical demultiplexer, the first optical multiplexer, the second optical demultiplexer, the second optical multiplexer, the third optical demultiplexer, and the third optical multiplexer each include an optical fiber coupler.

### (Supplementary Note 16)

An optical communication system including:
an optical transmitter configured to transmit an optical signal;
an optical receiver configured to receive the optical signal;
an optical fiber configured to transfer the optical signal; and
the optical repeater according to any one of supplementary notes 13 to 15 being inserted in the optical fiber.

An example advantage according to the above-described embodiments is that an optical repeater and an optical communication system can be provided whose voltage consumption is suppressed when an odd number of light sources are provided.

What is claimed is:

1. An optical repeater comprising at least n units being an odd number equal to or more than 3, wherein
the n units each include an excitation light source, a first optical demultiplexer, a second optical demultiplexer, a first optical multiplexer, and a second optical multiplexer,
the first optical demultiplexer demultiplexes excitation light from the excitation light source into 1:n−1,
the second optical demultiplexer demultiplexes, into n−1 pieces of excitation light, excitation light demultiplexed by the first optical demultiplexer with a ratio of n−1,
the second optical demultiplexer further outputs excitation light demultiplexed to each of the first optical multiplexers belonging to n−1 units other than a unit to which the second optical demultiplexer belongs,
the first optical multiplexer multiplexes, into a single piece of excitation light, excitation light being input by each of the optical demultiplexers belonging to n−1 units other than a unit to which the first optical multiplexer belongs, and outputs the single piece of excitation light to the second optical multiplexer, and
the second optical multiplexer multiplexes excitation light demultiplexed by the first optical demultiplexer with a ratio of 1 and the single piece of excitation light multiplexed by the first optical multiplexer.

2. The optical repeater according to claim 1, wherein each of the n units further includes
a wavelength division multiplexing coupler configured to multiplex an optical signal, and excitation light multiplexed by the second optical multiplexer, and
an optical amplifier configured to input and amplify light multiplexed by the wavelength division multiplexing coupler.

3. The optical repeater according to claim 1, wherein the first optical demultiplexer, the first optical multiplexer, the second optical demultiplexer, and the second optical multiplexer each include an optical fiber coupler.

4. An optical communication system comprising:
an optical transmitter configured to transmit an optical signal;
an optical receiver configured to receive the optical signal;
an optical fiber configured to transfer the optical signal; and
the optical repeater according to claim 1 being inserted in the optical fiber.

5. An optical repeater comprising at least n units being an odd number equal to or more than 3, wherein
the n units each include an excitation light source, an optical demultiplexer, and an optical multiplexer,
the optical demultiplexer demultiplexes excitation light from the excitation light source into n pieces of excitation light,
the optical demultiplexer further outputs the n pieces of excitation light to the optical multiplexers of the n units, respectively, and
the optical multiplexer multiplexes, into a single piece of excitation light, pieces of excitation light being input by the optical demultiplexers of the n units.

6. The optical repeater according to claim 5, wherein each of the n units further includes
a wavelength division multiplexing coupler configured to multiplex an optical signal, and excitation light multiplexed by the optical multiplexer, and
an optical amplifier configured to input and amplify light multiplexed by the wavelength division multiplexing coupler.

7. The optical repeater according to claim 5, wherein the optical demultiplexer and the optical multiplexer each include an optical fiber coupler.

8. An optical communication system comprising:
an optical transmitter configured to transmit an optical signal;
an optical receiver configured to receive the optical signal;
an optical fiber configured to transfer the optical signal; and
the optical repeater according to claim 5 being inserted in the optical fiber.

9. An optical repeater comprising:
a first unit including a first excitation light source, a first optical demultiplexer, a second optical demultiplexer, a first optical multiplexer, and a second optical multiplexer;
a second unit including a second excitation light source, a third optical demultiplexer, a fourth optical demultiplexer, a third optical multiplexer, and a fourth optical multiplexer; and
a third unit including a third excitation light source, a fifth optical demultiplexer, a sixth optical demultiplexer, a fifth optical multiplexer, and a sixth optical multiplexer, wherein
the first optical demultiplexer demultiplexes, in 1:2, excitation light being output by the first excitation light source, into first excitation light with a ratio of 1 and second excitation light with a ratio of 2,
the third optical demultiplexer demultiplexes, in 1:2, excitation light being output by the second excitation light source, into third excitation light with a ratio of 1 and fourth excitation light with a ratio of 2,
the fifth optical demultiplexer demultiplexes, in 1:2, excitation light being output by the third excitation light source, into fifth excitation light with a ratio of 1 and sixth excitation light with a ratio of 2,
the second optical demultiplexer demultiplexes the second excitation light in 1:1 into second primary excitation light and second secondary excitation light,
the fourth optical demultiplexer demultiplexes the fourth excitation light in 1:1 into fourth primary excitation light and fourth secondary excitation light,
the sixth optical demultiplexer demultiplexes the sixth excitation light in 1:1 into sixth primary excitation light and sixth secondary excitation light,
the first optical multiplexer multiplexes the fourth primary excitation light and the sixth primary excitation light into seventh excitation light,
the third optical multiplexer multiplexes the second primary excitation light and the sixth secondary excitation light into eighth excitation light,
the fifth optical multiplexer multiplexes the second secondary excitation light and the fourth secondary excitation light into ninth excitation light,
the second optical multiplexer multiplexes the first excitation light and the seventh excitation light,
the fourth optical multiplexer multiplexes the second excitation light and the eighth excitation light, and
the sixth optical multiplexer multiplexes the third excitation light and the ninth excitation light.

10. The optical repeater according to claim 9, wherein
the first unit further includes a first wavelength division multiplexing coupler configured to multiplex a first optical signal, and excitation light multiplexed by the second optical multiplexer, and a first optical amplifier configured to input and amplify light multiplexed by the first wavelength division multiplexing coupler,
the second unit further includes a second wavelength division multiplexing coupler configured to multiplex a second optical signal, and excitation light multiplexed by the fourth optical multiplexer, and a second optical amplifier configured to input and amplify light multiplexed by the second wavelength division multiplexing coupler, and
the third unit further includes a third wavelength division multiplexing coupler configured to multiplex a third optical signal, and excitation light multiplexed by the sixth optical multiplexer, and a third optical amplifier configured to input and amplify light multiplexed by the third wavelength division multiplexing coupler.

11. The optical repeater according to claim 9, wherein the first optical demultiplexer, the second optical demultiplexer, the first optical multiplexer, the second optical multiplexer, the third optical demultiplexer, the fourth optical demultiplexer, the third optical multiplexer, the fourth optical multiplexer, the fifth optical demultiplexer, the sixth optical demultiplexer, the fifth optical multiplexer, and the sixth optical multiplexer each include an optical fiber coupler.

12. An optical communication system including:
an optical transmitter configured to transmit an optical signal;
an optical receiver configured to receive the optical signal;
an optical fiber configured to transfer the optical signal; and
the optical repeater according to claim 9 being inserted in the optical fiber.
